(19) United States
(12) Patent Application Publication
(10) Pub. No.: US 2011/0291796 A1
(43) Pub. Date: Dec. 1, 2011

(54) SYSTEM OF A NUMBER OF REMOTELY CONTROLLABLE SCREENS, SUCH AS WINDOW COVERINGS, A REMOTE CONTROL FOR OPERATING THE SCREENS AND A METHOD INTENDED FOR APPLICATION WITH THE SYSTEM

(75) Inventor: Cornelis Bernardus Johannes Gradussen, Tiel (NL)

(73) Assignee: COULISSE B.V., Enter (NL)

(21) Appl. No.: 13/122,782

(22) PCT Filed: Sep. 9, 2009
(86) PCT No.: PCT/NL09/50574

§ 371 Date: May 20, 2011

(30) Foreign Application Priority Data
Oct. 6, 2008 (NL) 2002063

(51) Int. Cl. G05B 19/02

(52) U.S. Cl. 340/4.3

(57) ABSTRACT

A system of remotely controlled screens including a transmitter and a receiver including a memory at each screen adapted to successively select each screen by setting them into the selected mode and to establish communication between the remote and each screen in the selected mode.

### TECHNICAL FIELD

The invention relates to a system of a number of remotely controllable screens, such as window coverings, and a remote control for operating the screens, wherein the remote control comprises a transmitter for transmitting control signals and wherein each of the screens is provided with a receiver for receiving the control signals and with a memory for storing data from the remote control. The invention also relates to a method intended for application with the system according to the invention.

### BACKGROUND OF THE INVENTION

The invention fits in a trend in the field of screens, such as window coverings, toward automating the operation thereof. There are a number of aspects here which are important in practice, including convenience of use and the cost aspect.

A system according to the preamble is known in practice. The present invention has for its object to provide such a system with an enhanced convenience of use.

The system according to the invention has for this purpose the feature that the remote control and each of the screens are provided with a transceiver which is adapted to successively select each of the screens by setting them into a selected mode with the remote control and to establish communication between the remote control and each screen in the selected mode for the purpose of setting the screen in the selected mode.

The system according to the invention has the important advantage that selection of the relevant window coverings for control by the remote control can be performed wholly by means of the remote control, this considerably enhancing convenience of use.

### SUMMARY OF THE INVENTION

In a first preferred embodiment each screen is provided with a temporary memory for storing data relating to the selection of the screen and with a permanent memory for storing data relating to setting of the screen. The temporary memory is overwritable and preferably serves for storing information relating to the most recent selection round. Partly for this reason a small memory in the remote control will suffice, this considerably simplifying embodiment of the remote control and considerably reducing production costs thereof.

In an elegant preferred embodiment the remote control is adapted to send an inventory signal and each screen is adapted to send a reply to the inventory signal subject to predetermined conditions. In this preferred embodiment no physical contact is necessary to “turn on” each screen, but effecting of this contact takes place by means of the remote control. In practice this is a significant advantage in many situations, particularly when setting screens at positions which are difficult to access and/or in the case of a large number of screens. Some examples are external sunblinds and project layout in large spaces such as offices.

In a further development of this elegant preferred embodiment the inventory signal comprises a code for the purpose of identifying a screen to be selected, this identification code being intended for storage in the temporary memory of the screen to be selected. The inventory signal also comprises information relating to a setting session, this session information likewise being intended for storage in the temporary memory of the screen to be selected. In order to ensure that the screen only executes control signals from an authorized remote control, the inventory signal comprises identification information relating to the remote control, this remote control identification information being intended for storage in the temporary memory of the screen to be selected.

In a practical embodiment the conditions entail that the screen to be selected in the relevant session has not yet stored any remote control identification information in the memory AND that the screen to be selected has not yet stored the combination of identification code, session information, remote control identification information from the inventory signal in the temporary memory OR that the session information or the remote control identification information in the temporary memory differs from the session information or the remote control identification information from the inventory signal.

For the purpose of recognizing the selected screen during setting of the remote control, each of the screens is provided with indicator means adapted to visualize the selected mode.

The invention also relates to a method intended for application with the system according to the invention, which method is intended for the purpose of setting one or more of the screens such that they can be operated by means of the remote control, comprising the steps of:

(a) successively selecting each of the screens by setting them into a selected mode with the remote control, and

(b) establishing communication between the remote control and each screen in the selected mode for the purpose of setting the screen in the selected mode.

Further advantageous embodiments of the method according to the invention are described in the subclaims.

### BRIEF DESCRIPTION OF THE DRAWINGS

The invention will now be described with reference to the figures, in which

FIG. 1 shows schematically a preferred embodiment of a system according to the invention; and

FIG. 2 shows a flow diagram by way of illustrating the method according to the invention.

### BEST MODE TO CARRY OUT THE INVENTION

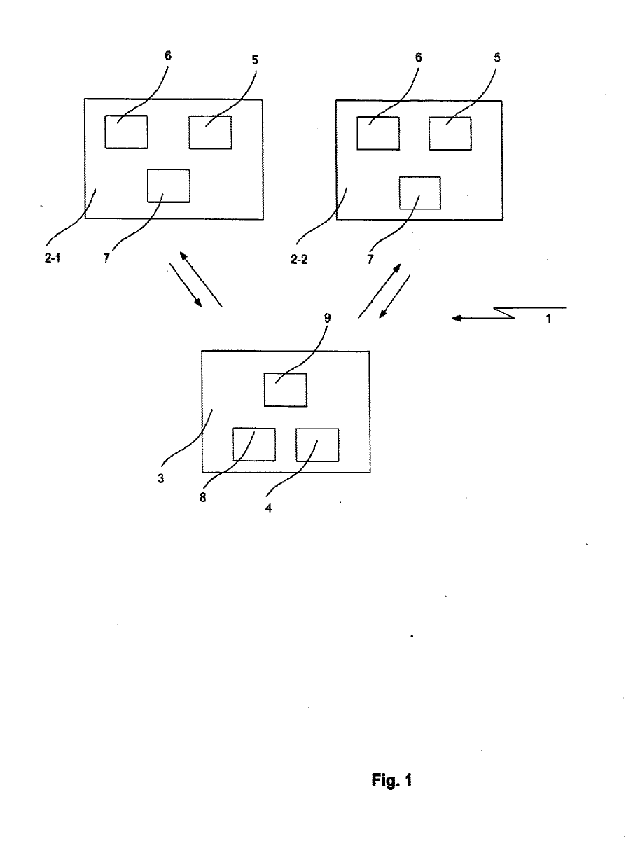

FIG. 1 shows a system 1 according to the invention. In this example system 1 comprises two remotely controllable window coverings 2-1, 2-2 and a remote control 3 for operating the window coverings.

Remote control 3 comprises a transceiver 4 for transmitting control signals. Each of the window coverings 2-1, 2-2 is provided with a transceiver 5 for receiving the control signals.

Remote control 3 also has a memory comprising a permanent memory 8 and a temporary memory 9. The temporary memory is intended for storing data in relation to performing of the method according to the invention. The individual serial number of remote control 3 is also stored in permanent memory 8. A small memory will suffice due to the use of the system and the method according to the invention, since the remote control does not need to store a list of controllable screens. A relatively small display will also suffice.

Each window covering 2-1, 2-2 also has a memory, comprising a permanent memory 6 and a temporary memory 7. The temporary memory is intended for storing data in relation to performing of the method according to the invention. A small memory with room for three variables will suffice. The individual serial number of the relevant window covering 2-1, 2-2 is stored in permanent memory 6, in addition to a list of authorized remote controls and settings.

Transceivers 4, 5 are adapted to transmit and receive radio-frequency signals, preferably with a frequency of substantially 2.4 GHz, i.e. in the 2.4 GHz ISM band. The 2.4 GHz ISM band is still available internationally and is highly suitable for application in this invention.

The remote control and the window coverings comprise control units adapted to perform the method according to the invention.

Suitable transmitters/receivers, temporary and permanent memories are commercially available. Use is preferably made in both the remote control and in the window coverings of integrated circuits provided with a transceiver, microprocessor, EEPROM, SRAM and flash memory.

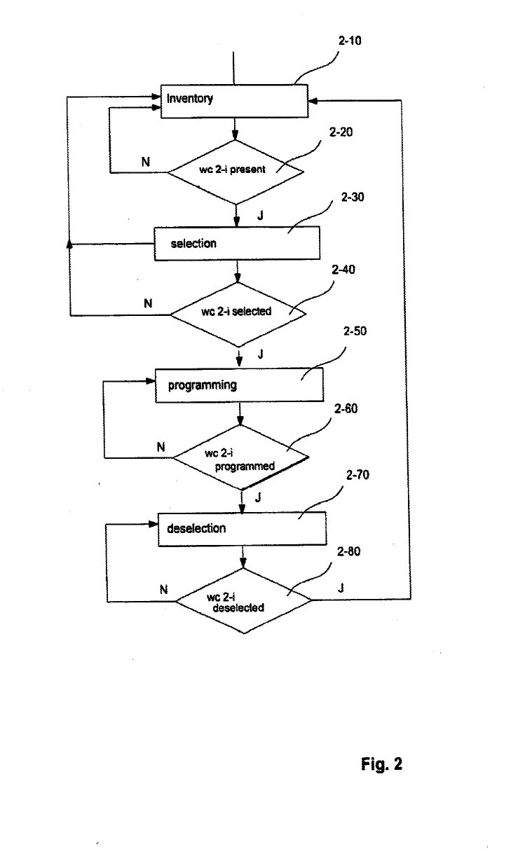

The method according to the invention can be subdivided into four important functions, which will be further elucidated hereinbelow with reference to FIG. 2. The method can be applied with any number of window coverings 2-i, with i=1, . . . , n, wherein n is a whole number. In the system shown in FIG. 1 n=2.

Function 1 Inventory

The purpose of this function is to determine whether a window covering 2-i is present in a space.

Step 2-10 illustrates schematically the inventory function and comprises the following steps.

In a first step a first timer is started for the purpose of the inventory function.

In a following step transceiver 4 of remote control 3 then transmits an inventory signal. The inventory signal comprises a code intended for the purpose of identifying the window covering to be selected or programmed in the subsequent process. The inventory signal also comprises information relating to the present setting session. The inventory signal moreover comprises identification information relating to remote control 3, for instance the serial number of the remote control.

This inventory signal is received by all window coverings 2-i.

Each window covering 2-i performs an inventory check.

Transceiver 5 of window covering 2-i sends a reply to transceiver 4 of remote control 3, this reply depending on the outcome of the inventory check.

A first condition for sending a presence signal in response to the inventory signal by the present window covering is that no remote control identification information at all is as yet stored in permanent memory 6 of the relevant window covering, or that the stored code corresponds to the remote control identification information from the inventory signal. A second condition for the present window covering sending a presence signal in response to the inventory signal is that the combination of identification code, session information and remote control identification information from the inventory signal is stored in temporary memory 7 of the relevant window covering. A third condition is that the session information or the remote control identification information in temporary memory 7 differs from the session information or the remote control identification information from the inventory signal.

When the first condition AND the second OR the third condition are met, the relevant window covering 2-i sends a reply in the form of a presence signal. The presence signal comprises the individual serial number of the present window covering and the information from the inventory signal.

The reply from window coverings 2-i is assessed in step 2-20. When a first presence signal is received, function 2 is started. If no presence signal is received, steps 2-10 and 2-20 are repeated until the first timer stops.

Function 2 Selection

The purpose of this function is selection of the present window covering 2-i. The term “present” window covering 2-i is understood in the following to mean the window covering from which a presence signal is received first.

Step 2-30 illustrates schematically the selection function and comprises the following steps.

A second timer is started for the purpose of the selection function.

Transceiver 4 of remote control 3 then transmits a selection signal.

This selection signal is intended only for the present window covering 2-i. The selection signal therefore comprises the content of the presence signal and a selection command. It is noted for the sake of completeness that, if the identification code had an unknown value during the inventory function, a value is now assigned thereto.

The present window covering 2-i recognizes this selection command after comparison with permanent memory 6. After receiving this selection signal the present window covering 2-i stores its assigned identification code in temporary memory 7, in addition to the session information and the remote control identification information. The remote control is now temporarily authorized.

The present window covering 2-i is now in the selected mode.

Each window covering 2-i is further provided with indicator means 7 for the purpose of visualizing to the user that the window covering is in the selected mode. These means can for instance be means for causing tumbling of the horizontal slats of blinds. Another option is a lamp on the rail for the window covering which begins to flash or is on continuously when the window covering is in the selected mode.

Transceiver 5 of the selected window covering 2-i sends a reply in the form of a selection confirmation signal to transceiver 4 of remote control 3. The selection confirmation comprises the serial number of the selected window covering and all information from the selection signal.

The reply from window covering 2-i is assessed in step 2-40. If the reply is a selection confirmation signal, function 3 is then started. If no selection confirmation signal is received, the steps of 2-30 are then repeated until the second timer stops.

Function 3 Programming/Operation

The purpose of this function is operation of the selected window covering 2-i for the purpose of setting and programming thereof. One of the operating options is the storage of the remote control identification information in the permanent memory. The remote control is then permanently authorized.

Step 2-50 illustrates schematically the programming function and comprises the following steps.

A third timer is first started for the programming function.

The preferred settings of the selected window covering can then be programmed by the user using the remote control. Groups of window coverings can for instance be defined. Individual settings can also be programmed, such as height position and tumble position, with associated limits and preferred positions and so on.

In step 2-60 the programming status of the selected window covering 2i is assessed.

When programming is completed, function 4 is started. As long as the programming is not completed, the steps of 2-50 are repeated until the third timer stops.

Function 4 Deselection

The purpose of this function is deselection of the programmed window covering 2-i.

Step 2-70 illustrates schematically the deselection function and comprises the following steps.

A fourth timer is started for the deselection function.

The remote control sends a deselection signal to the programmed window covering 2-i. The deselection signal comprises the serial number of window covering 2-i and a deselection command. The programmed window covering 2-i recognizes this selection command after comparison with permanent memory 6 and exits the selected mode. For confirmation purposes the programmed window covering 2-i sends a deselection confirmation signal back to the remote control. The deselection confirmation signal comprises a deselection confirmation and all information from the deselection signal. Window covering 2-i can now be operated by means of remote control 3.

The reply from window covering 2-i is assessed in step 2-80. If the reply is a deselection confirmation signal, function 1 is then started. If a deselection confirmation signal is not received, the steps of 2-70 are then repeated until the fourth timer stops.

The invention can be applied to all types of screens with a motorized drive. The invention is expressly not limited to the described and shown embodiment, but comprises all variants thereof which fall within the scope of protection of the appended claims, as seen in the light of the accompanying figures.

1. A system of a number of remotely controllable screens, such as window coverings, and a remote control for operating the screens, wherein the remote control comprises a transmitter for transmitting control signals and wherein each of the screens is provided with a receiver for receiving the control signals and with a memory for storing data from the remote control, characterized in that the remote control and each of the screens are provided with a transceiver which is adapted to successively select each of the screens by setting them into a selected mode with the remote control and to establish communication between the remote control and each screen in the selected mode for the purpose of setting the screen in the selected mode.

2. A system as claimed in claim 1, wherein each screen is provided with a temporary memory for storing data relating to the selection of the screen and a permanent memory for storing data relating to setting of the screen.

3. A system as claimed in claim 1, wherein the remote control is adapted to send an inventory signal, and wherein each screen is adapted to send a reply to the inventory signal subject to predetermined conditions.

4. A system as claimed in claim 3, wherein the inventory signal comprises a code for the purpose of identifying a screen to be selected, in addition to information relating to a setting session and identification information relating to the remote control, this identification code, session information and remote control identification information being intended for storage in the temporary memory of the screen to be selected.

5. A system as claimed in claim 4, wherein the conditions entail that the screen to be selected has not yet stored any remote control identification information in the permanent memory.

6. A system as claimed in claim 5, wherein the conditions further entail that the screen to be selected has not yet stored the combination of identification code, session information, remote control identification information from the inventory signal in the temporary memory, or that the session information or the remote control identification information in the temporary memory differs from the session information or the remote control identification information from the inventory signal.

7. A system as claimed in claim 1, wherein each of the screens is provided with indicator means adapted to visualize the selected mode.

8. A method intended for application with the system as claimed in claim 1, which method is intended for the purpose of setting one or more of the screens such that they can be operated by means of the remote control, comprising the steps of:
(a) successively selecting each of the screens by setting them into a selected mode with the remote control, and
(b) establishing communication between the remote control and each screen in the selected mode for the purpose of setting the screen in the selected mode.

9. A method as claimed in claim 8, wherein step (a) comprises of:
1) the remote control sending an inventory signal;
2) the screens sending a presence signal in response to the inventory signal subject to predetermined conditions;
3) the remote control sending a selection signal to the screen from which a presence signal is received first.

10. A method as claimed in claim 9, further comprising of:
including a code in the inventory signal for the purpose of identifying the screen of step 3, and storing the identification code in the temporary memory of the screen of step 3;
including information relating to a setting session in the inventory signal, and storing the session information in the temporary memory of the screen of step 3; and
including identification information relating to the remote control, and storing the remote control identification information in the temporary memory of the screen of step 3.

11. A method as claimed in claim 10, wherein the conditions of step 9-2 entail that no remote control identification information has yet been stored in the memory of the screen.

12. A method as claimed in claim 11, wherein the conditions of step 9-2 further entail that no combination of identification code, session information, remote control identification information from the inventory signal has yet been stored in the memory of the screen, or that the session information or the remote control identification information in the temporary memory differs from the session information or the remote control identification information from the inventory signal.

13. Method as claimed in claim 8, further comprising step c) of deselecting the selected screen with the remote control after setting of the selected screen has been completed.
